(19) United States
(12) Patent Application Publication
(10) Pub. No.: US 2018/0224685 A1
(43) Pub. Date: Aug. 9, 2018

(54) DISPLAY SUBSTRATE, DISPLAY DEVICE AND CURVED SURFACE DISPLAY DEVICE

(71) Applicants: BOE TECHNOLOGY GROUP CO., LTD., Beijing (CN); BEIJING BOE DISPLAY TECHNOLOGY CO., LTD., Beijing (CN)

(72) Inventors: Xibin SHAO, Beijing (CN); Hebin ZHAO, Beijing (CN); Yingying QU, Beijing (CN); Honglin ZHANG, Beijing (CN); Feifei WANG, Beijing (CN); Seungmin LEE, Beijing (CN)

(21) Appl. No.: 15/737,209

(22) PCT Filed: May 19, 2017
(86) PCT No.: PCT/CN2017/085058

§ 371 Date: Dec. 15, 2017

(30) Foreign Application Priority Data
May 31, 2016 (CN) 201610373453.8

(51) Int. Cl. G02F 1/13363

(52) U.S. Cl. CPC G02F 1/13363; G02F 2413/08; G02F 2413/05; G02F 2413/01

(57) ABSTRACT

Embodiments of the present disclosure provide a display substrate, a display device and a curved surface display device. The display substrate is used for a display device comprising a liquid crystal layer, which display substrate comprises: a base substrate; and a first compensation film on a side of the base substrate. The first compensation film is configured to compensate for a phase delay of light emitted from the liquid crystal layer

### CROSS REFERENCE TO RELATED APPLICATION

The present application is the U.S. national phase entry of PCT/CN2017/085058, with an international filling date of May 19, 2017, which claims the priority of the Chinese patent application No. 201610373453.8 filed on May 31, 2016, the disclosures of which are referenced herein in its entirety as part of this application.

### FIELD

The present disclosure relates to the field of display technology, and in particular, to a display substrate, a display device, and a curved surface display device.

### BACKGROUND

Liquid Crystal Displays (LCDs) have been widely applied in the field of display technology. However, problems such as light leakages in dark states prevalently exist in LCDs due to the birefringence phenomenon of the liquid crystal and the array substrate in the LCDs. In particular, light leakages in dark states are relatively serious for Advanced Super Dimension Switch (ADS) type of LCDs and In-Plane Switching (IPS) type of LCDs.

### SUMMARY

According to an aspect, an embodiment of the present disclosure provides a display substrate for a display device comprising a liquid crystal layer. The display substrate comprises: a base substrate; and a first compensation film on a side of the base substrate, wherein the first compensation film is configured to compensate for a phase delay of light emitted from the liquid crystal layer.

According to a further embodiment, the first compensation film is a +A compensation film, and an angle between an optical axis of the +A compensation film and a long axis of liquid crystal molecules in an initial state of the liquid crystal layer is α, wherein 80′≤α≤90°.

According to a further embodiment, α=90°.

According to a further embodiment, the first compensation film is a −A compensation film, and an angle between an optical axis of the −A compensation film and a long axis of liquid crystal molecules in an initial state of the liquid crystal layer is β, wherein 0°≤β≤10°.

According to a further embodiment, β=0°.

According to a further embodiment, the display substrate further comprises a second compensation film. The second compensation film is located between the base substrate and the first compensation film or located on a side of the first compensation film facing away from the base substrate. The second compensation film is configured to compensate for a phase delay of non-axial light.

According to a further embodiment, the second compensation film is a +C compensation film, and an angle between an optical axis of the +C compensation film and a long axis of liquid crystal molecules in an initial state of the liquid crystal layer is γ, wherein 80′≤γ≤90°.

According to a further embodiment, γ=90°.

According to a further embodiment, both the first compensation film and the second compensation film are a liquid crystal film.

According to a further embodiment, the display substrate further comprises a first alignment layer and a second alignment layer.

According to a further embodiment, the first alignment layer is located between the first compensation film and the base substrate, and the second alignment layer is located between the first compensation film and the second compensation film.

According to a further embodiment, the first alignment layer is located between the first compensation film and the second compensation film, and the second alignment layer is located between the second compensation film and the base substrate.

According to a further embodiment, the display substrate is a substrate at a light output side of the display device comprising the liquid crystal layer.

According to another aspect, an embodiment of the present disclosure provides a display device comprising a first substrate and a liquid crystal layer. The display device further comprises a display substrate as described above. The display substrate and the first substrate are assembled, such that the first compensation film faces the first substrate, and the liquid crystal layer is located between the first substrate and the display substrate.

According to an embodiment, in the display device, the first substrate is an array substrate, and the display substrate is a color film substrate.

According to a further embodiment, in the display device, the first substrate is a Color-filter-on-Array (COA) substrate, and the display substrate is a package substrate.

According to still another aspect, an embodiment of the present disclosure provides a curved surface display device, which is formed by bending a display device as described above.

### BRIEF DESCRIPTION OF THE DRAWINGS

In order to illustrate the technical solutions in embodiments of the present disclosure more clearly, the appended drawings to be used in the description of embodiments will be introduced briefly in the following. Obviously, the drawings in the following description are only some embodiments of the present disclosure. For those of ordinary skills in the art, other drawings may also be obtained according to these drawings under the premise of not paying out creative work.

FIG. 1 is a structure diagram for an ADS liquid crystal display device in related art;

FIG. 2 is a structure diagram for a display substrate provided by an embodiment of the present disclosure;

FIG. 3 is a schematic principle diagram for light leakages in dark states occurred in the display device as shown in FIG. 1;

FIG. 4 is a structure diagram for another display substrate provided by an embodiment of the present disclosure;

FIG. 5 is a structure diagram for still another display substrate provided by an embodiment of the present disclosure;

FIG. 6 is a schematic principle diagram for a non-axial viewing angle difference appearing in a known display device;

FIG. 7 is a structure diagram for another display substrate provided by an embodiment of the present disclosure;

FIG. 8 is a structure diagram for still another display substrate provided by an embodiment of the present disclosure;

FIG. 9 is a structure diagram for a display device provided by an embodiment of the present disclosure;

FIG. 10 is a distribution map for light leakages in dark states according to a known ADS liquid crystal curved surface display device;

FIG. 11 is a distribution map for light leakages in dark states according to an ADS liquid crystal curved surface display device, arranged with a first compensation film (+A compensation film) and a second compensation film (+C compensation film), provided by an embodiment of the present disclosure;

FIG. 12 is a path diagram for the polarization state in the propagation direction of light in an ADS liquid crystal curved surface display device, arranged with a first compensation film (+A compensation film) and a second compensation film (+C compensation film), provided by an embodiment of the present disclosure;

FIG. 13 is a schematic diagram for the polarization states of incident light and non-axial emergent light in an ADS liquid crystal curved surface display device, arranged with a first compensation film (+A compensation film) and a second compensation film (+C compensation film), provided by an embodiment of the present disclosure;

FIG. 14 is a method for forming a display substrate provided by an embodiment of the present disclosure; and

FIG. 15 is another method for forming a display substrate provided by an embodiment of the present disclosure.

### DETAILED DESCRIPTION OF THE EMBODIMENTS

In the following, the technical solutions in embodiments of the present disclosure will be described clearly and completely in conjunction with the drawings in the embodiments of the present disclosure. Obviously, the described embodiments are just a part of the embodiments of the present disclosure, and not all of the embodiments. Based on the embodiments in the present disclosure, all the other embodiments obtained by those of skills in the art under the premise of not paying out creative work pertain to the scope protected by the present disclosure.

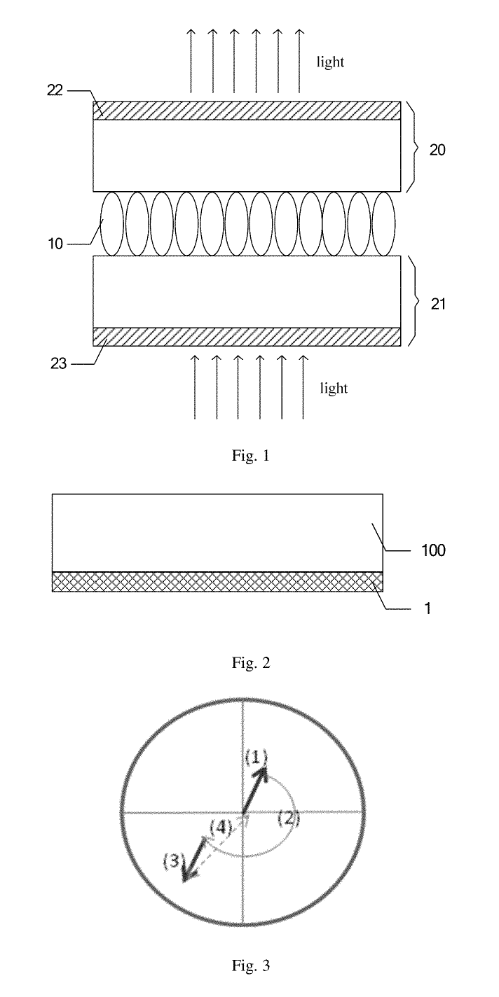

In related art. As shown in FIG. 1, the ADS type of LCD may comprise a color film substrate 20 and an array substrate 21 that are assembled, as well as a liquid crystal layer 10 located between the color film substrate 20 and the array substrate 21. To achieve normal display, on a side of the color film substrate 20 away from the liquid crystal layer 10 and on a side of the array substrate 21 away from the liquid crystal layer 10 are arranged an upper polarizer 22 and a lower polarizer 23 respectively, of which the absorption axes are perpendicular to each other. Since liquid crystals cannot emit light, a backlighting source is further needed to be arranged in the LCD. Light emitted by the backlighting source (not shown in FIG. 1) successively passes through the lower polarizer 23, the array substrate 21, the liquid crystal layer 10, the color film substrate 20, and the upper polarizer 22, and finally exits.

Liquid crystal molecules in the ADS type of LCDs are in a horizontal arrangement when at an initial state. In a case where no voltage is applied, the liquid crystal molecules have no distortion effect on light. The polarization direction of light after passing through the liquid crystal is perpendicular to the transmission axis of the upper polarizer 22. Therefore, light cannot transmit through the upper polarizer 22 to exit, and the LCD exhibits a dark screen. At this point, the ADS type of LCD is in a dark state. In a case where a voltage is applied, the liquid crystal molecules rotate and thereby distort light. Thus, the polarization direction of light is changed, such that light may exit through the upper polarizer 22, so as to cause the LCD to exhibit a bright screen. Then, the ADS type of LCD is in a bright state.

Generally, the base substrate of the array substrate is formed by glass, and yet the glass has a birefringence effect on light. Thus, when the ADS type of LCD is in the dark state, the birefringence phenomenon occurs to the light after passing through the array substrate, and its polarization state will be slightly changed. Afterwards, the birefringence phenomenon again occurs to the light after passing through the liquid crystal, its amount of phase delay is further increased, and the polarization state is evidently changed. Thus, the polarization direction of light emitted from the liquid crystal is no longer perpendicular to a direction along the transmission axis of the upper polarizer 22. In this case, part of the light will be transmitted out, thereby causing problems such as light leakages in dark states to be occurred in the ADS type of LCD.

An embodiment of the present disclosure provides a display substrate for a display device comprising a liquid crystal layer. As shown in FIG. 2, the display substrate comprises: a base substrate 100; and a first compensation film 1 on a side of the substrate 100. The first compensation film 1 is configured to compensate for a phase delay of light emitted from the liquid crystal layer.

It should be noted that, the display device (for example, a liquid crystal display device) comprising a liquid crystal layer needs a backlighting source to be able to implement display. The liquid crystal display device may comprise a color film substrate and an array substrate that are assembled, as well as a liquid crystal layer located between the color film substrate and the array substrate. A backlighting source is generally arranged at a side of the array substrate away from the liquid crystal layer. As such, light emitted by the backlighting source successively passes through the array substrate, the liquid crystal layer and the color film substrate. Therefore, the array substrate is a substrate at a light input side of the liquid crystal display device, and the color film substrate is a substrate at a light output side of the liquid crystal display device. The above-mentioned display substrate may be for example a color film substrate. Of course, different from the liquid crystal display device comprising a color film substrate and an array substrate, another kind of liquid crystal display device may comprise a package substrate and a COA substrate that are assembled, as well as a liquid crystal layer located between the package substrate and the COA substrate. The COA substrate generally refers to a substrate in which a color film layer is produced on an array substrate. A backlighting source may be arranged at a side of the COA substrate away from the liquid crystal layer. Light emitted by the backlighting source successively passes through the COA substrate, the liquid crystal layer and the package substrate. Therefore, the COA substrate is a substrate at a light input side of the liquid crystal display device, and the package substrate is a substrate at a light output side of the liquid crystal display device. The above-mentioned display substrate may be for example the package substrate.

The display substrate needs to be assembled with an opposed substrate so as to be able to form a liquid crystal display device. A side of the display substrate facing the opposed substrate may be called an inner side, and a side of the display substrate facing away from the opposed substrate may be called an outer side. In addition, meanings for inner sides and outer sides of individual film layers comprised in the display substrate are the same as those described above, and the specifics will not be repeated any more.

The specific film layers comprised in the display substrate will not be defined by the embodiments of the present disclosure. For example, the display substrate in the present disclosure may further comprise a black matrix, a color film layer, etc. located between the substrate and the first compensation film, which will not be described in detail here.

The display substrate may act as a substrate at a light output side of a planar liquid crystal display device, or may further act as a substrate at a light output side of a curved surface liquid crystal display device. Since the display screen of a curved surface liquid crystal display device (e.g., a curved surface liquid crystal television, etc.) is curved, problems such as light leakages in dark states there are more serious than that in a planar liquid crystal display device. For a curved surface liquid crystal display device in the present disclosure, the effect of mitigating or eliminating light leakages in dark states by the embodiments of the present disclosure is more significant.

In the following, the principle for improving light leakages in dark states will be described specifically.

Employing a Poincare sphere, FIG. 3 specifically illustrates the polarization state of light emitted by the backlighting source after passing through different film layers in the display device as shown in FIG. 1. It should be noted that, any point in the Poincare sphere represents a polarization state of light. Lines with arrows in FIG. 3 describe a path diagram for the polarization state of light in a propagation direction. Combining FIG. 1 and FIG. 3, (1) in FIG. 3 represents the polarization state of light after passing through the lower polarizer 23 and the array substrate 21; (2) represents the polarization state of light having passed the array substrate 21 after passing through the liquid crystal layer 10; (3) represents the polarization state of light having passed the liquid crystal layer 10 after passing through the color film substrate 20; and (4) reflects that problems such as light leakage have occurred. It can be seen from FIG. 3 that, because of a phase delay effect of the liquid crystal and the array substrate on light, there is a large difference between the polarization states of (1) and (3), leading to light exiting the upper polarizer 22, and thereby problems such as light leakage to occur.

Therefore, it can be seen from FIG. 3, offset of the phase delay of light by the liquid crystal molecules and the array substrate, namely, phase compensation for light emergent from the liquid crystal, may mitigate or avoid the light leakage in dark states. It should be noted that, phase delay will occur to light after it passes through a certain kind of crystal. For ease of describing such a phase delay, generally, the phase delay is divided into an in-plane phase delay RO and a thickness phase delay Rth. The phase delay effect of light by the liquid crystal is mainly reflected as the in-plane phase delay. When the above-described display substrate is used for a liquid crystal display device, the first compensation film may function to change the phase of light to offset the phase delay of light caused by the liquid crystal molecules and the array substrate. Thus, the light leakage in dark states may be mitigated or avoided, thereby improving the contrast ratio (CR).

Embodiments of the present disclosure provide a display substrate comprising the first compensation film arranged on a side of the base substrate. As such, in a liquid crystal display device formed after the display substrate is assembled with an opposed substrate, light passes through the opposed substrate and the liquid crystal layer, and then is incident on the display substrate. The first compensation film can compensate for the phase delay of light emitted from the liquid crystal layer, such that after the light passes through the opposed substrate, the liquid crystal layer and the first compensation film, its total phase delay is close or equal to zero. This in turn causes the light to be recovered to its original polarization state to a certain degree. Thus, when in a dark state, most of light cannot be emitted from the liquid crystal display device, thereby mitigating or avoiding the light leakage in dark states.

In the following, the concept of optical axis will be described. The phenomenon that two beams of refracted light is generated for a beam of light when it is incident on a certain kind of crystal is called birefringence. One of the two beams of refracted light obeys the usual law of refraction, which is called ordinary light, or o light for short. However, the other beam of refracted light does not obey the law of refraction, which is called extraordinary light, or e light for short. When the crystal is rotated, the refraction direction for the ordinary light is unchanged, whereas the refraction direction for the extraordinary changes with the direction of rotation. When the crystal is rotated to a certain direction, the refraction direction for the ordinary light coincides with that for the extraordinary light, and this direction is called the optical axis of the crystal. The concepts of optical axis of all the compensation films described below may be referred to the above explanation, and will not be described in detail any more in the following.

When the light leakage in dark states is induced, the phase delay of light caused by the liquid crystal is much larger than the phase delay of light caused by the glass substrate. Therefore, taking into account the difficulty of manufacture and the compensation effect, the first compensation film may for example only compensate for the phase delay generated by the liquid crystal. Since the phase delay of light by the liquid crystal is mainly reflected as the in-plane phase delay, it suffices for the first compensation film to be able to compensate for the in-plane phase delay. In the following, two exemplary structures will be provided.

According to an embodiment, the first compensation film is a +A compensation film, and an angle between an optical axis of the +A compensation film and a long axis of liquid crystal molecules in an initial state is α, wherein 80′≤α≤90°. The liquid crystal molecules in the initial state may be ones in a state in which no voltage is applied.

The +A compensation film (also called +A plate) satisfies nx1>ny1=nz1, wherein nx1 is the index of refraction along a X-axis direction in a plane of the +A compensation film, ny1 is the index of refraction along a Y-axis direction perpendicular to the X-axis in a plane of the +A compensation film, and nz1 is the index of refraction along a thickness direction of the +A compensation film.

The in-plane phase delay of the +A compensation film is R_{+A}=(nx1−ny1)*d1, wherein d1 is a thickness of the +A compensation film. The in-plane phase delay of the liquid crystal layer is R_{LC}=(nₑ−n₀)*d2, wherein d2 is a thickness of the liquid crystal layer, nₑ is the index of refraction of the extraordinary light, and n₀ is the index of refraction of the ordinary light. Related parameters for the +A compensation film are adjusted, such that R_{+A}+R_{LC}=0. That is, (nx1−ny1)*d1=(nₑ−n₀)*d2 is satisfied. As such, when the angle between the optical axis of the +A compensation film and the long axis of liquid crystal molecules in the initial state is between 80° and 90°, the +A compensation film may compensate for the in-plane phase delay generated after the light passes through the liquid crystal layer much better. According to an embodiment, the angle between the optical axis of the +A compensation film and the long axis of liquid crystal molecules in the initial state is α=90°. Thus, a better compensation effect can be achieved. The optical axis of the +A compensation film is right a direction in which the refraction directions of the o light and the e light generated after the light passes through the +A compensation film coincide. Of course, by adjusting related parameters of the +A compensation film, it may further compensate for the in-plane phase delay generated by the glass substrate, of which the principle is the same as that described above, and the specifics will not be described any more. In such a case, the +A compensation film can compensate for both the in-plane phase delay generated by the liquid crystal layer and the in-plane phase delay generated by the glass substrate simultaneously.

According to a further embodiment, the first compensation film is a −A compensation film, and the angle between the optical axis of the −A compensation film and the long axis of liquid crystal molecules in the initial state is β, wherein 0°≤β≤10°.

The −A compensation film (also called −A plate) satisfies nx2<ny2=nz2, wherein nx2 is the index of refraction along a X-axis direction in a plane of the −A compensation film, ny2 is the index of refraction along a Y-axis direction perpendicular to the X-axis in a plane of the −A compensation film, and nz2 is the index of refraction along a thickness direction of the −A compensation film.

The in-plane phase delay of the −A compensation film is R_{-A}=(nx2-ny2)*d3, wherein d3 is a thickness of the −A compensation film. The in-plane phase delay of the liquid crystal layer is R_{LC}=(nₑ−n₀)*d2, wherein d2 is a thickness of the liquid crystal layer, nₑ is the index of refraction of the extraordinary light, and n₀ is the index of refraction of the ordinary light. Related parameters for the −A compensation film are adjusted, such that R_{-A}+R_{LC}=0. That is, (nx2−ny2)*d3=(nₑ−n₀)*d2 is satisfied. As such, when the angle between the optical axis of the −A compensation film and the long axis of liquid crystal molecules in the initial state is between 0° and 10°, the −A compensation film may compensate for the in-plane phase delay generated after the light passes through the liquid crystal layer much better. The optical axis of the −A compensation film is right a direction in which the refraction directions of the o light and the e light generated after the light passes through the −A compensation film coincide. According to an embodiment, the angle between the optical axis of the −A compensation film and the long axis of liquid crystal molecules in the initial state is β=0°. Thus, a better compensation effect can be achieved. Of course, by adjusting related parameters for the −A compensation film, it may further compensate for the in-plane phase delay generated by the glass substrate, of which the principle is the same as that described above, and the specifics will not be described any more. In such a case, the −A compensation film can compensate for both the in-plane phase delay generated by the liquid crystal layer and the in-plane phase delay generated by the glass substrate simultaneously.

As show in FIG. 1, since absorption axes of the upper polarizer 22 and the lower polarizer 23 are perpendicular to each other, viewing the display device from an axial direction (which refers to a direction perpendicular to the display screen), the absorption axes of the upper polarizer 22 and the lower polarizer 23 are perpendicular to each other. However, viewing the display device from a non-axial direction (which refers to a direction not perpendicular to the display screen), the absorption axes of the upper polarizer 22 and the lower polarizer 23 are not perpendicular to each other. This will result in a small range of non-axial viewing angle, and cause problems such as color shift, etc., thereby affecting the viewing effect ultimately.

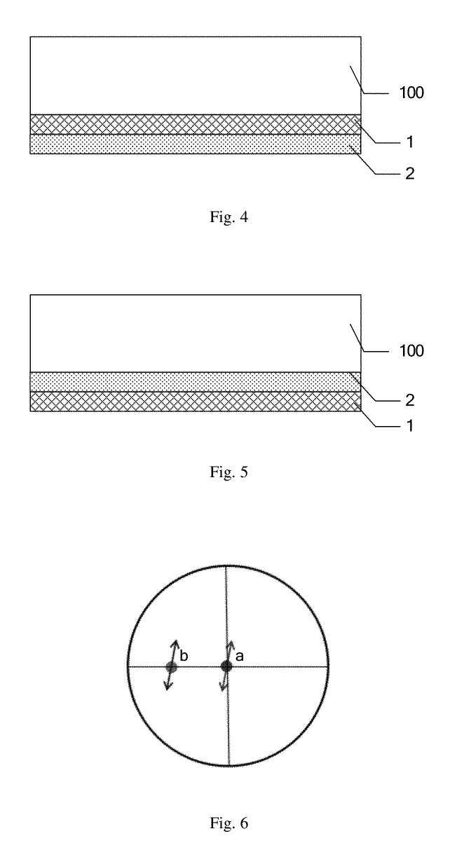

To improve the non-axial viewing angle, according to a further embodiment, the display substrate may further comprise a second compensation film. As shown in FIG. 4, the second compensation film 2 may be located on a side of the first compensation film 1 facing away from the substrate 100. Alternatively, as shown in FIG. 5, the second compensation film 2 may be located between the base substrate 100 and the first compensation film 1. The second compensation film 2 is configured to compensate for the phase delay of non-axial light.

In the following, the principle for improving the non-axial viewing angle will be described specifically.

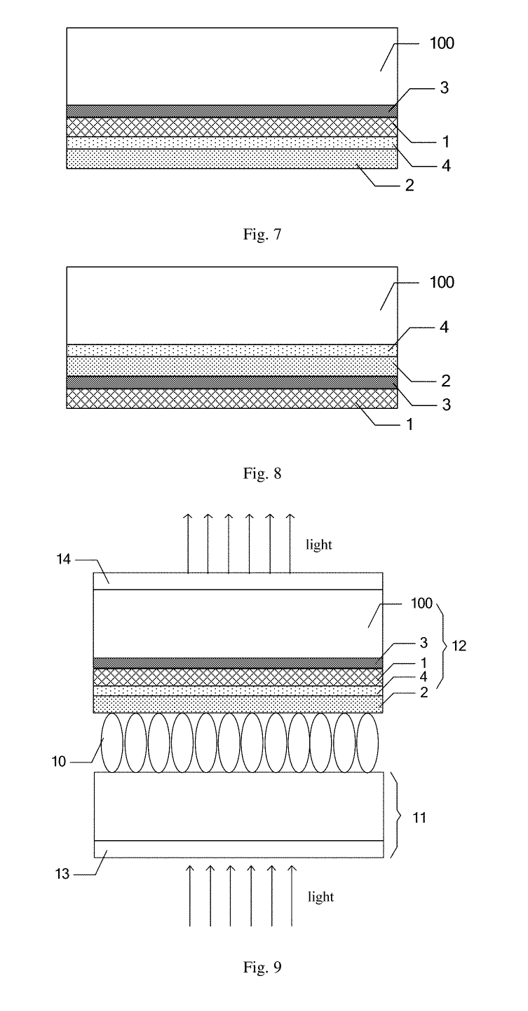

As shown in FIG. 6, a represents the polarization state of light (i.e., incident light) emitted by a backlighting source, and b represents the polarization state of emergent light emergent from the display device in a non-axial direction. The two polarization states differ greatly. The inventors have found that if the polarization state of non-axial emergent is caused to become identical to that of the incident light, the non-axial viewing angle will be improved greatly. According to an embodiment of the present disclosure, the non-axial viewing angle is improved based on such a principle. The present disclosure can improve the non-axial viewing angle by providing the second compensation film, such that it cooperates with the first compensation film to jointly compensate for the polarization state of non-axial emergent light.

When the display substrate comprising the first compensation film and the second compensation film is applied in a display device, the first compensation film and the second compensation film compensate for the phase delay of light. Under a joint action of the first compensation film and the second compensation film, the polarization state of non-axial light is improved, being close to the polarization state of axial light. Thus, when viewing the display device in a non-axial direction, the range of viewing angle is clearly improved, and the color shift is also mitigated. Moreover, the display device can further improve the light leakage in dark states.

According to a further embodiment, the second compensation film is a +C compensation film, and the angle between the optical axis of the +C compensation film and the long axis of liquid crystal molecules in the initial state is γ, wherein 80°≤γ≤90°.

The +C compensation film (also called +C plate) satisfies nz3>ny3=nx3, wherein nx3 is the index of refraction along a X-axis direction in a plane of the +C compensation film, ny3 is the index of refraction along a Y-axis direction perpendicular to the X-axis in a plane of the +C compensation film, and nz3 is the index of refraction along a thickness direction of the +C compensation film.

The thickness phase delay of the +C compensation film is Rth=[(nx3+ny3)/2−nz3]×d4, wherein d4 is a thickness of the +C compensation film. Since the +C compensation film satisfies nz3>ny3=nx3, its in-plane phase delay R_{+C}=0. That is, the in-plane phase delay of the +C compensation film is zero, and there is a phase delay only in the thickness direction. According to an embodiment, the angle between the optical axis of the +C compensation film and the long axis of liquid crystal molecules in the initial state is γ=90°. Thus, a good compensation effect may be achieved. The optical axis of the +C compensation film is right a direction in which the refraction directions of the o light and the e light generated after the light passes through the +C compensation film coincide. If the first compensation film is a +A compensation film or a −A compensation film, then the +A compensation film or the −A compensation film may compensate for the in-plane phase delay of light. Nevertheless, the +C compensation film as the second compensation film may compensate for the thickness phase delay of light. Under a joint action of the first compensation film and the second compensation film, the polarization state of non-axial light can be improved, thereby improving the non-axial viewing angle and the color shift. Moreover, the light leakage in dark states can further be improved.

According to a further embodiment, both the first compensation film and the second compensation film are a liquid crystal film, in order to reduce the production cost. It should be noted that, when both the first compensation film and the second compensation film are a liquid crystal film, the initial orientation of a liquid crystal molecule in the first compensation film and the initial orientation of a liquid crystal molecule in the second compensation film will not vary any longer once they are set, which is different from the case for the liquid crystal layer in the liquid crystal display device. To make orientations of individual liquid crystal molecules in the first compensation film be consistent and make orientations of individual liquid crystal molecules in the second compensation film be consistent, according to a further embodiment, the display substrate further comprises a first alignment layer 3 and a second alignment layer 4. As shown in FIG. 7, the first alignment layer 3 may be located between the first compensation film 1 and the base substrate 100, and the second alignment layer 4 may be located between the first compensation film 1 and the second compensation film 2. Alternatively, as shown in FIG. 8, the first alignment layer 3 may be located between the first compensation film 1 and the second compensation film 2, and the second alignment layer 4 may be located between the second compensation film 2 and the base substrate 100. The first alignment layer may make orientations of individual liquid crystal molecules in the first compensation film be consistent, and the second alignment layer may make orientations of individual liquid crystal molecules in the second compensation film be consistent. The first alignment layer and the second alignment layer may be arranged as shown in FIG. 7 or as shown in FIG. 8, which will not be defined here and may be selected according to the actual situation.

A further embodiment of the present disclosure provides a display device. As shown in FIG. 9, the display device comprises a first substrate 11 and a liquid crystal layer 10. The display device further comprises a display substrate 12 as described above. The display substrate 12 and the first substrate 11 are assembled, such that the first compensation film 1 faces the first substrate 11, and the liquid crystal layer 10 is located between the first substrate 11 and the display substrate 12.

The first substrate may be an array substrate, and then, the display substrate may be a color film substrate. The first substrate may also be a COA substrate, and at this point, the display substrate may be a package substrate.

As shown in FIG. 9, the display device may further comprise a first polarizer 13 on an outer side of the first substrate 11 and a second polarizer 14 on an outer side of the display substrate 12 so as to achieve normal display. Of course, the display device may further comprise other assemblies, for example, a backlighting source, etc., which will not be described in detail any more here.

The type of display devices will not be defined. Exemplarily, the display device may be a TN type of LCD, a VA type of LCD, an ADS type of LCD or an IPS type of LCD. Of course, the display device may further be a display device of other types, which will not be enumerated one by one any more here.

The display device as described above may be a liquid crystal display and any product or component with a display function, such as a television, a digital camera, a mobile phone, a tablet computer comprising a liquid crystal display. These display devices have advantages such as little light leakage in dark states, a large non-axial viewing angle, good contrast, and small color shift.

A further embodiment of the present disclosure provides a curved surface display device, which is formed by bending a display device as described above. The light leakage in dark states of the curved surface display device is effectively improved. In the following, an ADS liquid crystal curved surface display is taken as an example for illustrating the effects associated with the technical solution of the present disclosure.

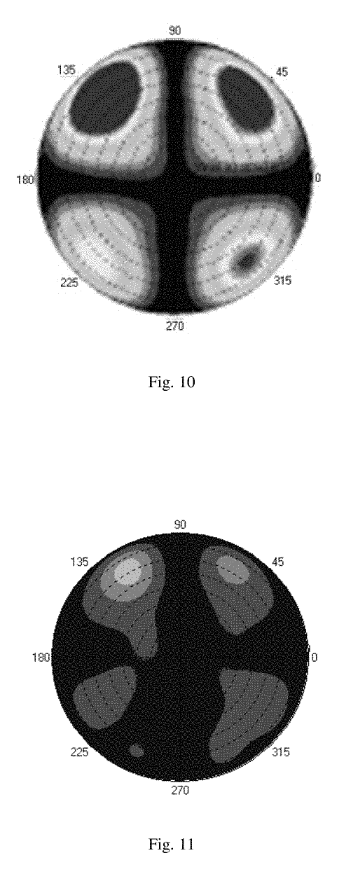

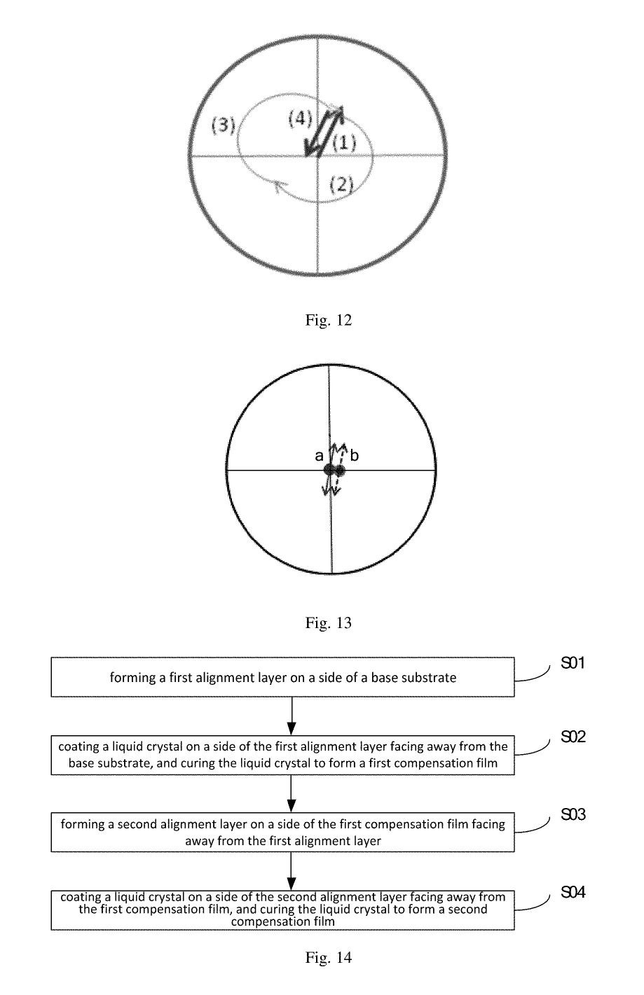

FIG. 10 shows a distribution map for light leakage in dark states according to a known ADS liquid crystal curved surface display device. FIG. 11 is a distribution map for light leakage in dark states according to an ADS liquid crystal curved surface display device, which is arranged with a first compensation film (+A compensation film) and a second compensation film (+C compensation film), of an embodiment of the present disclosure. By comparing FIG. 10 with FIG. 11, it can be seen that problems such as light leakage in four corners are effectively improved. As shown in FIG. 12, in an ADS liquid crystal curved surface display device arranged with a first compensation film (+A compensation film) and a second compensation film (+C compensation film), the +A compensation film and the +C compensation film compensate for light emitted from the liquid crystal, such that its polarization state is substantially recovered to its original polarization state. In conjunction with FIG. 11, it can be seen that the light leakage in dark states of the ADS liquid crystal curved surface display device is effectively improved. FIG. 13 is a schematic diagram for the viewing angle improvement in an ADS liquid crystal curved surface display device which is arranged with a first compensation film (+A compensation film) and a second compensation film (+C compensation film). It can be seen from FIG. 13 that, after the +A compensation film and the +C compensation film are arranged, the polarization state of incident light is very close to that of non-axial emergent light. This indicates that the non-axial viewing angle of the display device is improved greatly. In other words, the ADS liquid crystal curved surface display device arranged with a +A compensation film and a +C compensation film further effectively improves the non-axial viewing angle, while improving the light leakage in dark states.

The above-described curved surface display device may be a liquid crystal curved surface display and any product or component with a display function, such as a curved surface television, a curved surface digital camera, a curved surface mobile phone, a curved surface tablet computer comprising a liquid crystal curved surface display. The curved surface display device has advantages such as little light leakage in dark states, a large non-axial viewing angle, good contrast, and small color shift.

An embodiment of the present disclosure provides a method for manufacturing a display substrate as shown in FIG. 4. The method comprises the following steps.

At S001, a liquid crystal is coated on a side of the base substrate 100, and the liquid crystal is cured to form a first compensation film 1.

At S002, a liquid crystal is coated on a side of the first compensation film 1 facing away from the base substrate 100, and the liquid crystal is cured to form a second compensation film 2.

A further embodiment of the present disclosure provides a method for manufacturing a display substrate as shown in FIG. 5. The method comprises the following steps.

At S003, a liquid crystal is coated on a side of the base substrate 100, and the liquid crystal is cured to form a first compensation film 2.

At S004, a liquid crystal is coated on a side of the first compensation film 2 facing away from the base substrate 100, and the liquid crystal is cured to form a second compensation film 1.

A further embodiment of the present disclosure provides a method for manufacturing a display substrate as shown in FIG. 7. As shown in FIG. 14, the method comprises the following steps.

At S01, a first alignment layer 3 is formed on a side of the base substrate 100.

At S02, a liquid crystal is coated on a side of the first alignment layer 3 facing away from the base substrate 100, and the liquid crystal is cured to form a first compensation film 1. As such, orientations of individual liquid crystal molecules in the formed first compensation film 1 are consistent, and directions of orientation will not be changed any longer.

At S03, a second alignment layer 4 is formed on a side of the first compensation film 1 facing away from the first alignment layer 3.

At S04, a liquid crystal is coated on a side of the second alignment layer 4 facing away from the first compensation film 1, and the liquid crystal is cured to form a second compensation film 2. As such, orientations of individual liquid crystal molecules in the formed second compensation film 2 are consistent, and directions of orientation will not be changed any longer.

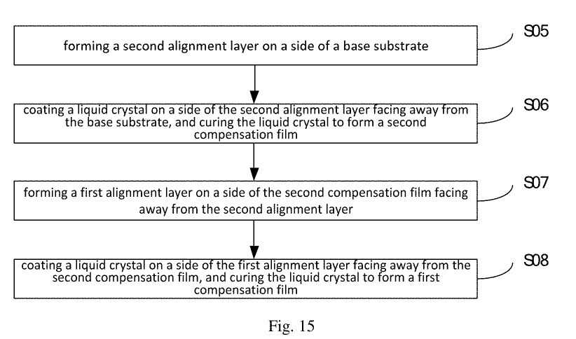

A further embodiment of the present disclosure provides a method for manufacturing a display substrate as shown in FIG. 8. As shown in FIG. 15, the method comprises the following steps.

At S05, a second alignment layer 4 is formed on a side of the base substrate 100.

At S06, a liquid crystal is coated on a side of the second alignment layer 4 facing away from the base substrate 100, and the liquid crystal is cured to form a second compensation film 2. As such, orientations of individual liquid crystal molecules in the formed second compensation film 2 are consistent, and directions of orientation will not be changed any longer.

At S07, a first alignment layer 3 is formed on a side of the second compensation film 2 facing away from the second alignment layer 4.

At S08, a liquid crystal is coated on a side of the first alignment layer 3 facing away from the second compensation film 2, and the liquid crystal is cured to form a first compensation film 1. As such, orientations of individual liquid crystal molecules in the formed first compensation film 1 are consistent, and directions of orientation will not be changed any longer.

What are described above are just specific embodiments of the present disclosure. However, the protection scope of the present disclosure is not limited thereto, and variations or alternatives easily occurring to any artisan familiar with the technical field within the technical scope disclosed by the present disclosure should be encompassed within the protection scope of the present disclosure. Therefore, the protection scope of the present disclosure should be subject to the protection scope of the appended claims.

1. A display substrate for a display device comprising a liquid crystal layer, which display substrate comprises:
a base substrate; and
a first compensation film on a side of the substrate, wherein the first compensation film is configured to compensate for a phase delay of light emitted from the liquid crystal layer.

2. The display substrate as claimed in claim 1, wherein the first compensation film is a +A compensation film, and an angle between an optical axis of the +A compensation film and a long axis of liquid crystal molecules in an initial state of the liquid crystal layer is α, wherein 80°≤α≤90°.

3. The display substrate as claimed in claim 2, wherein α=90°.

4. The display substrate as claimed in claim 1, wherein the first compensation film is a −A compensation film, and an angle between an optical axis of the −A compensation film and a long axis of liquid crystal molecules in an initial state of the liquid crystal layer is β, wherein 0°≤β≤10°.

5. The display substrate as claimed in claim 4, wherein 3=0°.

6. The display substrate as claimed in claim 1, further comprising a second compensation film, wherein
the second compensation film is located between the base substrate and the first compensation film or located on a side of the first compensation film facing away from the base substrate, and
the second compensation film is configured to compensate for a phase delay of non-axial light.

7. The display substrate as claimed in claim 6, wherein the second compensation film is a +C compensation film, and an angle between an optical axis of the +C compensation film and a long axis of liquid crystal molecules in an initial state of the liquid crystal layer is γ, wherein 80°≤γ≤90°.

8. The display substrate as claimed in claim 7, wherein γ=90°.

9. The display substrate as claimed in claim 6, wherein both the first compensation film and the second compensation film are a liquid crystal film.

10. The display substrate as claimed in claim 9, further comprising a first alignment layer and a second alignment layer.

11. The display substrate as claimed in claim 10, wherein the first alignment layer is located between the first compensation film and the base substrate, and the second alignment layer is located between the first compensation film and the second compensation film.

12. The display substrate as claimed in claim 10, wherein the first alignment layer is located between the first compensation film and the second compensation film, and the second alignment layer is located between the second compensation film and the base substrate.

13. The display substrate as claimed in claim 1, wherein the display substrate is a substrate at a light output side of the display device comprising the liquid crystal layer.

14. A display device comprising a first substrate and a liquid crystal layer, wherein
the display device further comprises a display substrate as claimed in claim 1, and
the display substrate and the first substrate are assembled, such that the first compensation film faces the first substrate, and the liquid crystal layer is located between the first substrate and the display substrate.

15. The display device as claimed in claim 14, wherein the first substrate is an array substrate, and the display substrate is a color film substrate; or the first substrate is a Color-filter-on-Array (COA) substrate, and the display substrate is a package substrate.

16. A curved surface display device, wherein the curved surface display device is formed by bending a display device as claimed in claim 14.

17. The display substrate as claimed in claim 6, wherein the first compensation film is a +A compensation film, and an angle between an optical axis of the +A compensation film and a long axis of liquid crystal molecules in an initial state of the liquid crystal layer is α, wherein 80°≤α≤90°.

18. The display substrate as claimed in claim 17, wherein α=90°.

19. The display substrate as claimed in claim 6, wherein the first compensation film is a −A compensation film, and an angle between an optical axis of the −A compensation film and a long axis of liquid crystal molecules in an initial state of the liquid crystal layer is β, wherein 0°≤β≤10°.

20. The display substrate as claimed in claim 19, wherein β=0°.
